(19) United States
(12) Patent Application Publication
(10) Pub. No.: US 2016/0077956 A1
(43) Pub. Date: Mar. 17, 2016

(54) SYSTEM AND METHOD FOR AUTOMATING TESTING OF SOFTWARE

(71) Applicants: Sourav Sam BHATTACHARYA, Fountain Hills, AZ (US); Mohammed ASHARAF, Bellevue, WA (US)

(72) Inventors: Sourav Sam BHATTACHARYA, Fountain Hills, AZ (US); Mohammed ASHARAF, Bellevue, WA (US)

(73) Assignee: Wipro Limited, Bangalore (IN)

(21) Appl. No.: 14/483,263

(22) Filed: Sep. 11, 2014

(51) Int. Cl. G06F 11/36

(52) U.S. Cl. CPC G06F 11/3688; G06F 11/3692

(57) ABSTRACT

The present disclosure relates to systems, methods, and non-transitory computer-readable media for automating testing of software. The method comprises receiving, the at least one test case. The at least one test case associated with at least one test platform may be executed. Further, a variable time delay may be interjected between successive runs for the at least one test case. The variable time delay based on inertia associated with the at least one test platform. A sequence of the one or more test results for the at least one test case may be built. Based on the one or more test results, an output consistency based on the one or more test results may be determined. Finally, a fault associated with the at least one test platform or a software based on the output consistency may be determined.

### TECHNICAL FIELD

The present disclosure relates generally to automating testing of software, and more particularly but not limited to automating testing of a software associated with a transient faulty test platform.

### BACKGROUND

Automating testing of software is one of the most sought after technology. Automation saves time, reduces cost, and eliminates human error. Test automation is always based on the assumption that the underlying test platform is stable and reliable. Therefore, objective of testing is to evaluate the functional correctness of (or the lack thereof) of software under test which is running on top of the test platform. For this reason, and with such assumption, the testing is conducted by running the software under test with a desired test input and output and validating the functional correctness.

However, if the underlying system's stability or correctness is not certain because of some transient fault, then the testing of the software under test may not provide a correct interpretation as to whether the software under test is faulty or the underlying test platform is faulty. Now the underlying test platform may be faulty on a steady basis or on a transient basis. The steady basis means that once failed the system does not recover on its own within a short interval. The transient basis means that the system recover on its own within a short period. In case of failure involving steady fault, the test engineer can separately assess the underlying test platform to evaluate if the test platform has been faulty or not. The assessment is based on the premise that if the test platform would have been faulty during the test execution, the same platform must be faulty now, and hence a post execution assessment of the platform can deterministically evaluate root cause of the test case failure.

However, in case of failure involving steady fault, no post-execution assessment of the underlying test platform can be made to determine what occurred at the time the test case was being executed. Examples of such transient faults include wireless noisy channels, memory overload, related errors, and in general any system component that due to physical nature of the environment or interconnection of a large number of complex systems may lead to sporadic failures that are On-again/Off-again nature.

Moreover, the underlying test platform may have differing timing characteristics when it comes to how long the platform may remain faulty if/when a transient fault occurs. For example, wireless channels recover usually within a few seconds. For example, wireless channels recover usually within a few seconds, as reflected in the common consumer experience in a cellular call that fails and immediate redialing appears to work correctly. Whereas, if the system is faulty due to an overload CPU or disk, then the recovery time may be in minutes and sometimes in scores of minutes.

In view of the above drawbacks, it would be desirable to have a mechanism to capture results and factors involved in execution of test case so that post execution review of the results may allow differentiating between a legitimate test case fail from an alleged test case failure caused by time varying characteristics of the test platform.

### SUMMARY

Disclosed herein is a method for automating testing of software. The method includes receiving, using one or more hardware processors, the at least one test case associated with at least one test platform; executing, using one or more hardware processors, the at least one test case associated with at least one test platform; interjecting, using one or more hardware processors, a variable time delay between successive runs for the at least one test case, the variable time delay based on at least inertia associated with the at least one test platform; building, using one or more hardware processors, a sequence of the one or more test results for the at least one test case; determining, using one or more hardware processors, an output consistency based on the one or more test results; and determining a fault associated with the at least one test platform or a fault in the software based on the output consistency.

In another aspect of the invention, a system for automating testing of a software is disclosed. The system includes one or more hardware processors; and a computer-readable medium storing instructions that, when executed by the one or more hardware processors, cause the one or more hardware processors to perform operations. The operations may include receiving, using one or more hardware processors, the at least one test case associated with at least one test platform; executing, using one or more hardware processors, the at least one test case associated with the at least one test platform; interjecting, using one or more hardware processors, a variable time delay between successive runs for the at least one test case, the variable time delay based on at least inertia associated with the at least one test platform; building, using one or more hardware processors, a sequence of the one or more test results for the at least one test case; determining, using one or more hardware processors, an output consistency based on the one or more test results; and determining a fault associated with the at least one test platform or a fault in the software based on the output consistency.

In yet another aspect of the invention, a non-transitory computer-readable medium storing instructions for automating testing of a software with at least one test platform is disclosed. The instructions that, when executed by the one or more hardware processors, cause the one or more hardware processors to perform operations. The operations may include receiving, using one or more hardware processors, the at least one test case associated with at least one test platform; executing, using one or more hardware processors, the at least one test case associated with the at least one test platform; interjecting, using one or more hardware processors, a variable time delay between successive runs for the at least one test case, the variable time delay based on at least inertia associated with the at least one transient faulty test platform; building, using one or more hardware processors, a sequence of the one or more test results for the at least one test case; determining, using one or more hardware processors, an output consistency based on the one or more test results; and determining a fault associated with the at least one test platform or a fault in software based on the output consistency.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

### BRIEF DESCRIPTION OF THE DRAWINGS

The accompanying drawings, which constitute a part of this specification, illustrate several embodiments and, together with the description, serve to explain the disclosed principles. In the drawings:

FIG. 1 is a block diagram of a high-level architecture of an exemplary system for automating testing of software in accordance with some embodiments of the present disclosure.

FIG. 2 illustrates a general purpose bell-shaped model for failure distribution of the test platform in accordance with some embodiments of the present disclosure.

FIG. 3 illustrates a finite state machine for computation of inter-test case execution delay and parameter used in consistency computation algorithm in accordance with some embodiments of the present disclosure.

FIG. 4 is a flowchart of an exemplary method for automating testing of software in accordance with some embodiments of the present disclosure that may be executed by the system

FIG. 5 is a block diagram of an exemplary computer system for implementing embodiments consistent with the present disclosure.

### DETAILED DESCRIPTION

As used herein, reference to an element by the indefinite article “a” or “an” does not exclude the possibility that more than one of the element is present, unless the context requires that there is one and only one of the elements. The indefinite article “a” or “an” thus usually means “at least one.” The disclosure of numerical ranges should be understood as referring to each discrete point within the range, inclusive of endpoints, unless otherwise noted.

As used herein, the terms “comprise,” “comprises,” “comprising,” “includes,” “including,” “has,” “having,” “contains,” or “containing,” or any other variation thereof, are intended to cover a non-exclusive inclusion. For example, a composition, process, method, article, system, apparatus, etc. that comprises a list of elements is not necessarily limited to only those elements but may include other elements not expressly listed. The terms “consist of,” “consists of,” “consisting of,” or any other variation thereof, excludes any element, step, or ingredient, etc., not specified. The term “consist essentially of,” “consists essentially of,” “consisting essentially of,” or any other variation thereof, permits the inclusion of elements, steps, or ingredients, etc., not listed to the extent they do not materially affect the basic and novel characteristic(s) of the claimed subject matter.

The present disclosure relates to a system and a method for automating execution of one or more test cases associated with a test platform. During the test execution, results and factors are captured so that post execution review of the results may allow differentiating between a legitimate test case fail [failure due to software under test] from an alleged test case failure caused by time varying characteristics of the test platform. For example, a test case may be run N times (N being an odd number) and use a voter logic to determine if majority are leading to same result. The running of the test case N times is based on the premise that the time varying characteristics of the test platform is not going to remain identical for all the N runs. Therefore, if there is a sporadic behavior in the underlying test platform, it will be caught when we run the test case N times and compare the test results.

The interval between successive runs of the same test case (TC) is controlled in the automated execution using an inertia associated with the test platform. For example, test platforms considered are a) wireless channels having inertia of few seconds b) disk load factors which could be in tens of minutes c) CPU load which could be in minutes, and the like. In another non-limiting example, N will not be a fixed number and N will vary based upon test case and the pattern of the test responses.

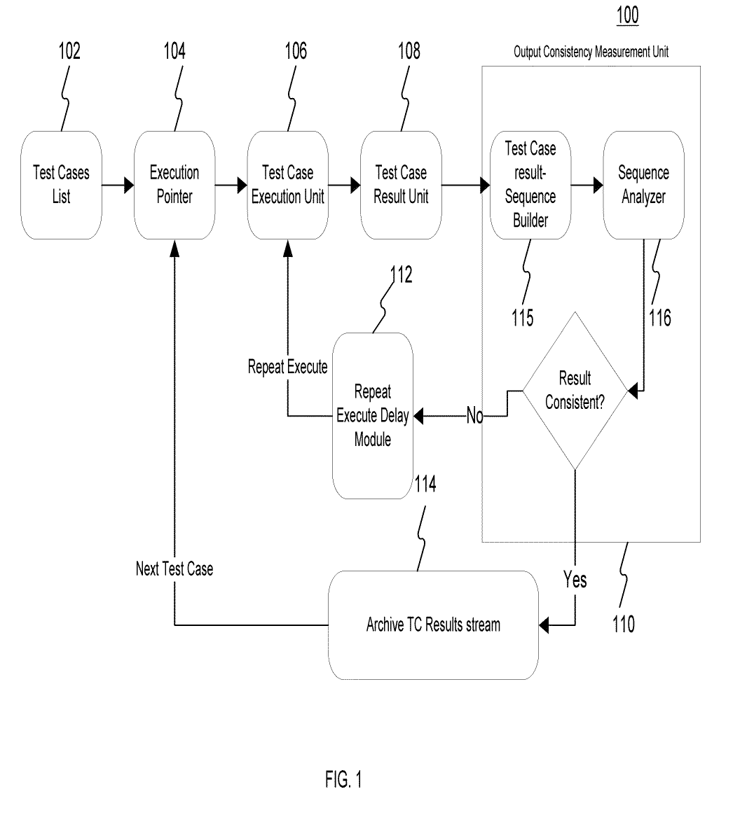

FIG. 1 is a block diagram of a high-level architecture of an exemplary system 100 for automating testing of software in accordance with some embodiments of the present disclosure. Automating testing of software involves execution of one or more test cases associated with a test platform. The test platform may be faulty based on transient basis or steady basis. Embodiments of the present disclosure have been described keeping into consideration that the underlying test platform may be faulty on transient basis, i.e. transient faulty test platform. There may be one or more than one transient faulty test platforms. In one embodiment, “faulty test platform” may include cell phones and over the air (OTA) connections. In another embodiment, “faulty test platform” may include devices on a rapidly moving system, e.g., cars, trains, planes, satellites, where the physical motion of the test platform may trigger unsteady or time-varying characteristics of the underlying system. In yet another embodiment, “faulty test platform” may include but not limited to platforms which are so complex that inherently provide random variations of test results, e.g., computer measurements on a human organ using a medical device, or memory leak in a large server, etc.

The system 100 comprises a test cases list 102, an execution pointer 104, a test case execution unit 106, test case result unit 108, an output consistency measurement unit 110, repeat execute delay module 112, and an archive TC results stream 114. The test cases list 102 is a list of test cases , 1 . . . N, that are scheduled to be executed , one after another. This list is input to the execution pointer 104 that keeps track of most recently executed and completed test case. The execution pointer 104 is initiated to beginning of the test case list 102, and proceeds to the next test case to be executed once/after the immediate previous test case has been completely executed. In some embodiments, if a test case that is supposed to be ready for execution, but has not been provided yet, the execution pointer 104 may skip the test case and move to the next available test case. In a software limitation, this execution pointer 104 is an index variable in a looping construct.

Further, the test case execution unit 106 may be responsible for executing a particular test case. The present disclosure may be independent of the specific test execution technology that may be involved. The present disclosure may interoperate with any or all test execution test execution technology platforms. All that matters from the perspective of the present disclosure is that the test case execution unit 106 will execute a test case, once designated by the execution pointer 106. Once the test case has been executed by the test case execution unit 106, the test case result unit 108 is responsible for capturing the outcome or test result. The test case result unit 108 records a Pass (=P) or Fail (=F) outcome of the test case.

Further, the output consistency measurement unit 110 may include a sequence builder 115 and a sequence analyzer 116 performing operations pertaining to the test case results. The sequence builder 115 may build a sequence of the (Pass, Fail) stream of test results for a specific test case ID, as the test case execution is repeated. For example, if a particular test case is executed 10 times, and the results stream as Pass, Pass, Fail, Fail, Pass, Pass, Fail, Fail, Fail and Pass—then this unit build a list as=[ P, P, F, F, P, P, F, F, F, P]. Note that the length of the sequence is variable and may change from one test case to another. The length may be reset to zero, when a new test case begins execution and as/when that particular test case is repeated the length increases by 1 for each additional execution. The sequence analyzer 116 may execute specific algorithms to determine whether there is consistency in the outcome or not. The test result sequence may be inputted to the sequence analyzer 116 and may be analyzed for consistency. The definition of “consistency” is core to the functioning of the algorithm. If the results stream is found consistent, the particular test case under assessment may be completed and the text execution may move to the next test case. However, if the results stream is not found consistent (determined by the consistency determination algorithms), it may mean that the test execution result has not been conclusive and hence the same test case is repeatedly executed.

Once it has been found that the results stream is not consistent and the test case is to be repeatedly executed, the repeat execute delay module 112 interjects a delay between successive runs of the same test case. The delay is computed as well as the value of N (which is a parameter used in the consistency generation) is determined.

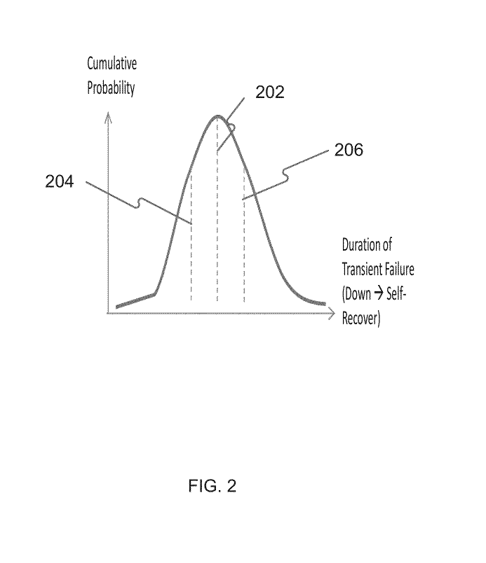

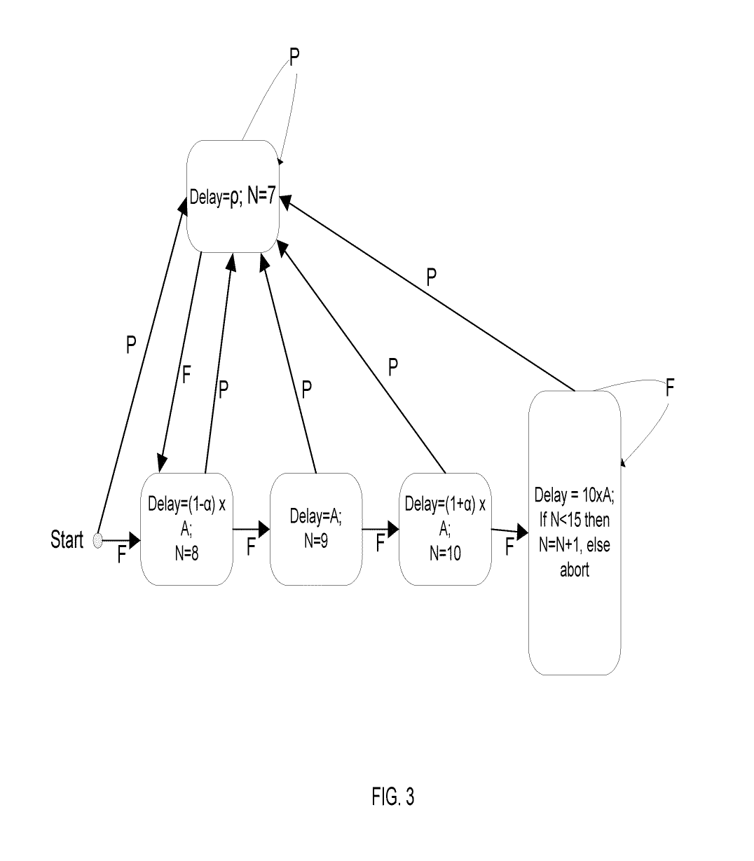

The computation of the delay between successive runs of the test case is explained in conjunction with FIGS. 2 and 3. Introduction of a variable delay between the successive runs of the same test case is key novel aspect of the present disclosure. The variable delay may a function of inertia associated with the underlying test platform. Inertia refers to the capability of the underlying test platform to recover in case of a transient failure. For example, wireless channel may go through a transient failure in the range of few seconds. Whereas some other physical media may have a longer transient failure intervals. For example, a disk related transient failure (caused typically by sector error and overloaded disk) may last several tens of minutes, until the disk is freed up. Likewise, a CPU overload related error may last several minutes. Idea is to capture the failure pattern, if detected, of the underlying test platform, and if faulty then take the test case repeat execution sequence through a time-cycle consistent to the inertia associated with the underlying test platform.

FIG. 2 illustrates a general purpose bell-shaped model for failure distribution of the underlying test platform (physical medium). It is pertinent to note that the present is not limited to any particular distribution. It can be any distribution. Main objective of the present disclosure is to capture the mid-point, or average (A) (shown by dotted line 202, and a lower threshold (shown by dotted line 204) of the average at (1−α) A, and an upper threshold (shown by the dotted line 206) of the average at (1+α) A. The value of α may vary. In one exemplary embodiment, the value of α may be 0.30. These two thresholds, lower and upper, along with the absolute value of the average may be used in determination of the delay factor inserted between successive executions of the same test case. The distribution may capture the duration of the transient failure from failure of the physical medium to the recovery of the physical medium.

FIG. 3 illustrates a finite state machine for computation of inter-test case execution delay and N (parameter used to Parameter N is used in consistency computation algorithm, explained in detail afterwards). Pass/fail sequence of the execution stream of the test cases leads to a) computation of the delay inserted between successive runs of the same test case, and b) computation of a parameter called N used in the consistency determination algorithm.

At the leftmost, start state is illustrated, which comes with a default value of N=7 and a very small time delay ρ. This state is entered even before the test case is executed. Each execution of the same test case (TC) proceeds through this state machine. A “P” represents a Pass in the immediate previous execution of the TC, while a “F” indicates a Fail. On the detection of the failure with the default values (N=7, ρ), a lower threshold 204 of the average 202 (i.e., ((1−α) A) is used. Next, if a continued fail occurs, then an average delay (A) is used. If the failure further continues, then an upper threshold 206 of the average 202 ((1+α) A) is used. The idea to oscillate between (1−α) A, A, and (1+α) A is to test if the underlying test platform is moving to a self-recovery, so that a pass may be detected post an immediate previous fail. At any time, on the detection of pass following an immediate fail, the state machine goes to the default values (N=7, ρ). As long as we get a pass outcome, the value of delay ρ and value of N=7 is kept constant. On the other hand, if the fail continues for 4^{th} (a design parameter that may be varied) in sequence, then the delay is made arbitrarily large, for example 10A. And, the delay stays at this value until the system continues to fail beyond a pre-set set threshold large number of times (=15, a design parameter chosen). The value of N is increased every time a succession of fail occurs.

If the test results stream is found to be consistent, archive test case results stream 114 stores the test case results stream, one stream for each test case ID.

The architecture shown in FIG. 1 may be implemented using one or more hardware processors (not shown), and a computer-readable medium storing instructions (not shown) configuring the one or more hardware processors. The one or more hardware processors and the computer-readable medium may also form part of the system 100.

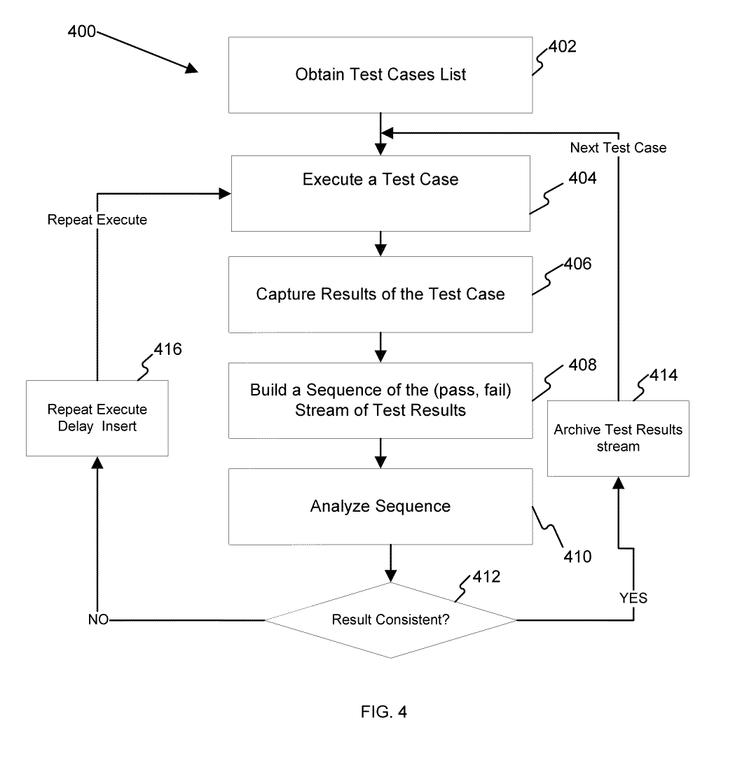

FIG. 4 is a flowchart 400 of an exemplary method for automating testing of software in accordance with certain embodiments of the present disclosure. The exemplary method may be executed by the system 100, as described in further detail below. It is noted however, the functions and/or steps of FIG. 4 as implemented by the system 100 may be provided by different architectures and/or implementations without departing from the scope of the present disclosure.

Referring to FIG. 4, at step 402, obtain the test cases list 102 comprising the test cases to be executed.

At step 404, execute a test case. In one embodiment, test cases are executed sequentially one after other. In another embodiment, the test cases are executed in parallel. In some embodiments, the execution pointer 104 may be used to successively iterate through the test cases list 102. It is pertinent to note that there are two types of loops that are being executed simultaneously. One loop pertain to the execution of the test cases and the second loop pertain to the execution of a test case more than once when the result of the test case is not found to be consistent and further iterations of the same test case is needed. The consistency of the test case may be determined by one or more algorithms, explained in great detail afterwards. When the test case is executed more than once, it results in an additional outcome (pass, fail). The results of the executed test cases are stored.

At step 406, capture the results or outcome of the executed test case by the test case result unit 108. The test case result unit 108 records a pass or fail outcome of the test case. The test case result unit 108 feeds the outcomes to the sequence builder 115.

At step 408, build a sequence of the (pass, fail) stream of test results for a the test case as the test case is repeatedly executed. The sequence builder 115 creates a list comprising of (pass, fail) outcome of an iterative execution of a particular test case.

At step 410, analyze the sequence of the test results for determining consistency of the outcome (pass, fail pattern).

At step 412, determination is made as to the consistency of the test result. If the test results are consistent, archive the test case results stream (step 414). If the test results are not consistent, repeat the execution of the test case and insert delay between the successive runs of the same test case (step 416). The consistency of the test case results stream may be determined by executing one or more algorithms. The algorithms are string processing algorithms, where the member of each string is a P or a F, indicating the pass or fail outcome of the test case execution.

In an embodiment of the present disclosure, algorithm 1 analyzes the (P,F) results stream to determine a consistency or stability in the results. The idea is to detect if the results (P, or F) are constantly oscillating, or are the results consistently merging to a fixed value (either P, or F but not both). This algorithm is unique because of its application to a repeated execution of the same test case, and in its approach to determine the trailing end of the stable/consistent results stream. The value of N used in this algorithm is computed as shown in FIG. 3.

Algorithm 1: Last-N Unanimous

Tests if the last N attempts to execute the test case (TC) has resulted in unanimous outcome

Logic: looking for steadiness and consistency in the results . . .

N is a design parameter, example N=5. TC execution and results outcome sequence (P=pass, F=fail) P, F, F, P, P, P, P, F, F, P, P, P, P, P [stop, conclude as Pass] P, F, F, F, F, F [stop, conclude as Fail]; failure may be with the test case or software under test.

P, P, P, P, P [stop, conclude as Pass]

F, F, F, F, F [stop, conclude as Fail]

F, P, F, P, F, P, F, P, . . . (for 100+times with never getting last-5 unanimous result) [stop, conclude as Abort]

In another embodiment of the present disclosure, algorithm 2 is an extension of algorithm 1. Unlike algorithm 1, which believes the results stream to be 100% steady, i.e., consistently all P's or consistently all F's, algorithm 2 believes that the steadiness does not require to be 100%, but a high value like 80% or 90% should suffice. As long as the steadiness factor is not getting low to a 50% or lower range—at which time the results are no longer steady but random—Algorithm 2 would detect a consistency at such high 8x % or 9x % steadiness. The uniqueness of Algorithm 2, beyond the uniqueness of Algorithm 1, is in incorporation of the threshold of steadiness, namely the 8x % or 9x % factor. The value of N used in this algorithm is computed as shown in FIG. 3. Algorithm 2: Last-N x % Unanimous

Tests if x % or more of the last N attempts to execute the TC has resulted in a common outcome

N is a design parameter, example N=5

X % is a design parameter, example x %=80%

TC execution and results outcome sequence (P=pass, F=fail)

P, F, F, P, F, P, P, F, F, P, P, P, P [stop, conclude as Pass, NB: 80% of 5 is 4.]

P, F, F, F, F [stop, conclude as Fail]

P, P, P, P [stop, conclude as Pass]

F, F, F, F [stop, conclude as Fail]

F, P, F, P, F, P, F, P, . . . (for 100+times with never getting last-4 unanimous result) [stop, conclude as Abort]

In yet another embodiment of the present disclosure, algorithm 3 approaches the consistency detection problem in an altogether different way. While algorithms 1 and 2 would continue repeating the same test case until either consistency is detected or a very large number of test case repeat occurs. Algorithm 3 emphasizes the cost of repetitive execution of the same test case and puts a fixed term limit on the number of times a test case shall be executed. Post execution of this fixed number of execution of the same test case, the consistency decision is by a majority result vote. algorithm 3 is unique since it is putting a cap on the number of times a particular test case is executed, which is neither 1 (as in the current test case execution practice) and nor a very high unlimited number. The next uniqueness of algorithm 3 is the application of voter logic, i.e., determining the consistency based upon majority logic.

Algorithm 3: fixed-length majority vote. Test case outcome is the majority of a pre-designated N attempts to execute the TC

N is a design parameter, example N=9. N is an odd number

TC execution and results outcome sequence (P=pass, F=fail)

P, F, F, P, P, P, P, F, F [stop, conclude as Pass, since 5 P′s and 4 F's]

F, F, F, F, F, P, P, P, P [stop, conclude as Fail, since 5 F's and 4 P's]

P, P, F, F, P, P, F, F, P [stop, conclude as Pass, since 5 P's and 4 F's]

In a further embodiment of the present disclosure, algorithm 4 approaches the consistency detection problem in a completely different way. Algorithm 4 differentiates between a pass and a fail as follows, with the following observation. The algorithm is based on the premise that a pass may only occur if both the underlying system is working properly and the software under test performed correctly. Whereas, a fail may occur either due to the underlying platform failing or the software under test not functioning correctly or both. In this sense, a Pass is a more definitive interpretation generating outcome than a Fail. A fail leaves with ambiguity, but a pass definitely means that the software under test performed correctly. With this delineation, algorithm 4 detects the first occurrence of pass in a fixed length. The fixed length selection logic is very similar to that in Algorithm 3. However, majority voter logic is not applied. Instead, the detection of one or more “Pass” result is searched for. A single Pass would indicate that the software under test must have performed correctly. The uniqueness of Algorithm 4 (in addition to the uniqueness as listed for Algorithm 3) is in the differentiating treatment over pass versus fail result, and banking on the pass results to make a definitive interpretation outweighing the Fail results.

Algorithm 4: First pass election in a fixed-length. Logic: A pass can happen only if the underlying system is non-faulty (at that instant) and the test case legitimately passed. Hence, a “Pass” is more conclusive than a “Fail”. Because, a “Fail” can happen either due to a functional failure of the system business logic OR an underlying system failure.

Test case result=P if there is at least one pass in a sequence of N TC execution results. N=a design parameter. TC execution and results outcome sequence (P=pass, F=fail)

P, F, F, P, P, P, P, F, F [stop, conclude as Pass, since at least 1 P is there]

P, P, F, F, P, P, F, F, P [stop, conclude as Pass, since at least 1 P is there]

F, F, F, F, F, F, F, F, F [stop, conclude as Fail, since no P is there]

In yet another embodiment of the present disclosure, algorithm 5 utilizes a rule based approach, where the rules capture the decision logic. The uniqueness of algorithm 5 is in its usage of rules. Another key aspect of this algorithm is that it takes a holistic view of the system. Algorithm 5 applies rule based pass criteria for the entire system.

This is one step above the previous algorithms. This aggregates the test result of each individual TCs and derive a pass/fail for the entire system. And these can be configured as business rules. Logic: A pass for the entire set of test cases can happen only if the criteria specified by the user or tester are met. In this model, either all the test cases are run in one cycle, repeatedly (i.e TC1-TC200 are run multiple times OR TC-1 multiple times, TC-2 multiple times.). Here individual results from each test cases are used to derive the overall pass/fail state for system.

Until the decision criteria is met with, the same test case is repeatedly executed.

The outer loop is executed when the previous test case ID is concluded and the execution moves on to the next test case ID. If the test cases list 102 is already exhausted, then the flow stops and the method execution is completed.

Once/after a consistency decision is arrived at, the next available test case is selected for execution by first updating the test execution pointer 104 and then repeating the test execution process.

The present disclosure executes each test case (TC) as a logically distinct and singleton entity. However, underlying idea may be extended to logically related or precedence based TCs as well. Example, TC1's completion is required prior to launching TC3 and TC7. In such cases, logically each TC is evaluated (to determine if the software under test is faulty or the underlying platform is faulty) in a system and method similar to that disclosed in the present disclosure. However, launch of a downstream precedent graph TC may not start until all its precondition TCs have been completed. The system will require a scheduler box at the entry point of the TC list, and this scheduler box may implement the logic to pick up the next available and ready TC to execute. In some embodiments, the scheduler box follows a linearly numbered TC selection mechanism, as all the TCs are unrelated. However, in some other embodiments, the scheduler box may maintain the precedence information, possibly in the format of a precedence graph, and follow the precedence graph to schedule the launch of the next available TC.

The present disclosure does incorporate multiple underlying platforms. For example, CPU, memory, and TCP/IP connection paths may be three distinct underlying platforms, the failure of one or more of which may lead to the failure of the test case. However, the present disclosure does not make any assumption between a fault causality between multiple platforms. In a practical environment, often faults are interrelated. As an example, a memory fault could lead to a deadlock in page swap at the operating system (OS) level which triggers a CPU starvation and hence a CPU bandwidth failure. These types of dependent platform failures (amongst one or more underlying platforms) may be extended to apply to the present disclosure as well. The extension of the system and method may be as follows: a) when determining the number of times to execute a particular TC for a specific underlying platform (example: Memory) one must take into consideration that it is more than one platform (example: Memory that triggers a failure into CPU as well) and devise the TC execution sequence that fits the failure pattern for multiple platforms together; b) when determining the output result, e.g., whether the software under test is at fault or the underlying platform is at fault, the latter interpretation may be extended to a multi-platform causality triggered failure. As an example, a CPU platform determined failure may require to be interpreted as a memory platform caused fault. Such causality analysis can be done with aid of platform log files that document which platform was faulty or unavailable at what time instants.

The present disclosure predominantly considers platform failures of type “non-available”. For example, CPU that is overloaded and not having enough cycles, or network (TCP/IP) channels that are congested and unable to deliver packets in expected time duration. Each such “non-available” failures (aka. denial-of-service) lead to a non-functioning of the software under test, which is reported as a test case execution failure. However, the “non-available” failure can easily be extended to failure of other types. Example, consider a memory at stuck failure, where the memory cells are stuck at either 1 or 0 (bits), and unable to maintain a 1:1 consistency between what is written onto the memory versus what is read out. In such cases, the end result of the executed test case may not be a denial of service error, but a functional error (i.e., producing a result value, but an incorrect result value—as opposed to not producing any result value at all). The part of the system that compares the execution results with the expected result may be extended to capture both situations—a) non-completing test result, and b) incorrectly completing test result.

### Exemplary Computer System

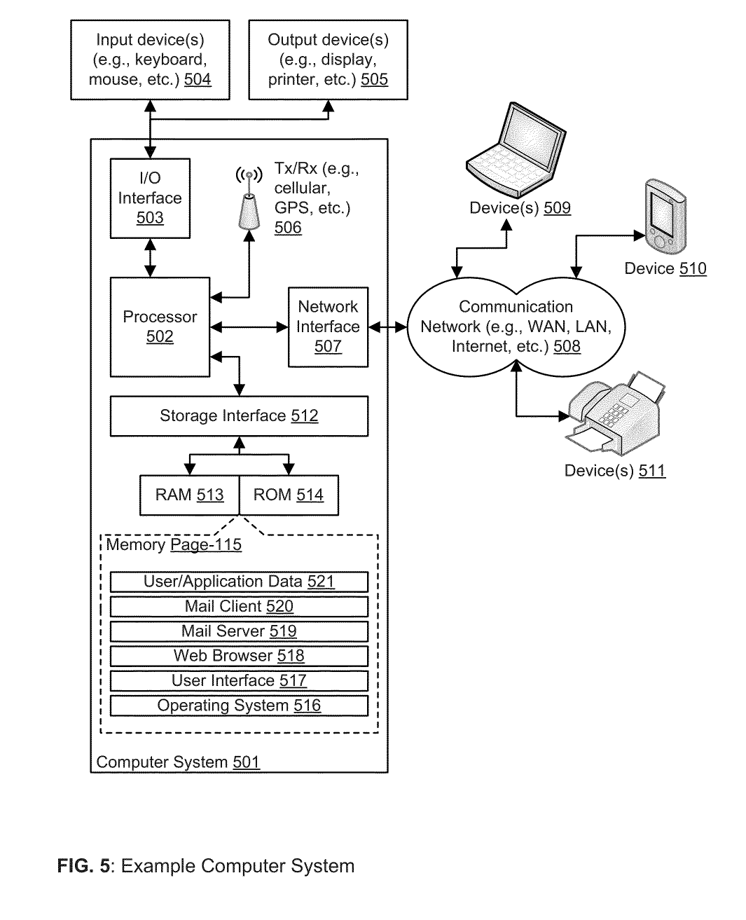

FIG. 5 is a block diagram of an exemplary computer system for implementing embodiments consistent with the present disclosure. Variations of computer system 501 may be used for implementing any of the devices and/or device components presented in this disclosure, including system 100. Computer system 501 may comprise a central processing unit (CPU or processor) 502. Processor 502 may comprise at least one data processor for executing program components for executing user- or system-generated requests. A user may include a person using a device such as such as those included in this disclosure or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 518-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for automating testing of a software, the method comprising:
receiving, using one or more hardware processors, at least one test case associated with at least one test platform;
executing, using one or more hardware processors, the at least one test case associated with the at least one test platform;
interjecting, using one or more hardware processors, a variable time delay between successive runs for the at least one test case, the variable time delay based on at least inertia associated with the at least one test platform;
building, using one or more hardware processors, a sequence of one or more test results for the at least one test case;
determining, using one or more hardware processors, an output consistency based on the one or more test results for the at least one test case; and
determining, using one or more hardware processors, a fault associated with the at least one test platform or the software based on the output consistency.

2. The method of claim 1, wherein the inertia comprises at least one of a time interval to recover by faulty wireless channel, a time interval to recover in faulty disk, a time interval to recover in loaded CPU, a time interval to recover in loaded memory, and a time interval to recover in a congested network channel.

3. The method of claim 1, wherein number of times the at least one test case is executed is fixed initially based on the respective inertia associated with the at least one test platform.

4. The method of claim 1, wherein distinct repetitive runs for the at least one test case is performed, at least one run of the distinct repetitive runs being performed for each of the at least one test platform.

5. The method of claim 1, wherein number of times the at least one test case is executed varies based on nature of the at least one test case and pattern of the one or more test results.

6. The method of claim 1, wherein the variable time delay varies from a predefined lower threshold to a predefined upper threshold.

7. The method of claim 1, wherein determining the output consistency comprises:
testing if last N test results to execute a test case result in an unanimous outcome, N being a design parameter.

8. The method of claim 1, wherein determining the output consistency comprises:
testing if predefined percentage or more than the predefined percentage of the last N test attempts to execute the at least one test case results in a common outcome, N being a design parameter.

9. The method of claim 1, wherein determining the output consistency comprises:
determining majority of predetermined N attempts to execute the at least one test case, N being a design parameter.

10. The method of claim 1, wherein determining the output consistency comprises:
testing if there is at least one pass outcome in fixed length string of the one or more test results;

11. The method of claim 1, wherein determining the output consistency comprises:
determining pass/fail state of at least one of the software and the at least one test platform by aggregating individual test results from each of the at least one test case;

12. A system for automating testing of a software, the system comprising:
one or more hardware processors; and
a computer-readable medium storing instructions that, when executed by the one or more hardware processors, cause the one or more hardware processors to perform operations comprising:
receiving, using one or more hardware processors, at least one test case associated with at least one test platform;
executing, using one or more hardware processors, the at least one test case associated with the at least one test platform;
interjecting, using one or more hardware processors, a variable time delay between successive runs for the at least one test case, the variable time delay based on at least inertia associated with the at least one test platform;
building, using one or more hardware processors, a sequence of one or more test results for the at least one test case;
determining, using one or more hardware processors, an output consistency based on the one or more test results; and
determining, using one or more hardware processors , a fault associated with the at least one test platform or the software based on the output consistency.

13. The system of claim 12, wherein the inertia comprises at least one of a time interval to recover by faulty wireless channel, a time interval to recover in faulty disk, a time interval to recover in loaded CPU, a time interval to recover in loaded memory, and a time interval to recover in a congested network channel.

14. The system of claim 12, wherein the medium stores further instructions that, when executed by the one or more hardware processors causes the one or more hardware processors to perform operations comprising: fixing initially number of times the at least one test case is executed, the fixing based on the respective inertia associated with the at least one test platform.

15. The system of claim 12, wherein the medium stores further instructions that, when executed by the one or more hardware processors causes the one or more hardware processors to perform operations comprising: performing distinct repetitive runs for the at least one test case, at least one run of the distinct repetitive runs being performed for each of the at least one test platform.

16. The system of claim 12, wherein number of times the at least one test case is executed varies based on nature of the at least one test case and pattern of the one or more test results.

17. The system of claim 12, wherein the variable time delay varies from a predefined lower threshold to a predefined upper threshold.

18. The system of claim 13, wherein the operation of determining the output consistency comprises:
testing if last N test results to execute the at least one test case result in an unanimous outcome, N being a design parameter.

19. The system of claim 12, wherein the operation of determining the output consistency comprises:
testing if predefined percentage or more than the predefined percentage of the last N test attempts to execute the at least one test case results in a common outcome, N being a design parameter.

20. The system of claim 12, wherein the operation of determining the output consistency comprises:
determining majority of predetermined N attempts to execute the at least one test case, N being a design parameter.

21. The system of claim 12, wherein the operation of determining the output consistency comprises:
testing if there is at least one pass outcome in fixed length string of the one or more test results;

22. The system of claim 12, wherein the operation of determining the output consistency comprises:
determining pass/fail state of at least one of the software and the at least one test platform by aggregating individual test results from each of the at least one test case;

23. A non-transitory computer-readable medium storing instructions for automating testing of a software that, when executed by the one or more hardware processors, cause the one or more hardware processors to perform operations comprising:
receiving, using one or more hardware processors, at least one test case associated with at least one test platform;
executing, using one or more hardware processors, the at least one test case associated with at least one test platform;
interjecting, using one or more hardware processors, a variable time delay between successive runs for the at least one test case, the variable time delay based on at least inertia associated with the at least one transient faulty test platform;
building, using one or more hardware processors, a sequence of the one or more test results for the at least one test case;
determining, using one or more hardware processors, an output consistency based on the one or more test results for the at least one test case; and
determining, using one or more hardware processors ,a fault associated with the at least one test platform or the software based on the output consistency.
